(19) United States
(12) Patent Application Publication
(10) Pub. No.: US 2024/0312175 A1
(43) Pub. Date: Sep. 19, 2024

(54) RECOGNITION DEVICE, RECOGNITION METHOD, RECOGNITION PROGRAM, MODEL LEARNING DEVICE, MODEL LEARNING METHOD, AND MODEL LEARNING PROGRAM

(71) Applicant: NIPPON TELEGRAPH AND TELEPHONE CORPORATION, Tokyo (JP)

(72) Inventors: Jun ITO, Tokyo (JP); Noriko YOKOYAMA, Tokyo (JP); Chihiro YAMAMOTO, Tokyo (JP); Kazuaki OBANA, Tokyo (JP)

(73) Assignee: NIPPON TELEGRAPH AND TELEPHONE CORPORATION, Tokyo (JP)

(21) Appl. No.: 18/557,023

(22) PCT Filed: Apr. 28, 2021
(86) PCT No.: PCT/JP2021/017091

§ 371 Date: May 16, 2024

(51) Int. Cl. G06V 10/26; G06V 10/764; G06V 10/77; G06V 10/776; G06V 20/68

(52) U.S. Cl. CPC G06V 10/26; G06V 10/764; G06V 10/7715; G06V 10/776; G06V 20/68

(57) ABSTRACT

A recognition device includes a data extraction unit, a recognition unit, and a ratio estimation unit. The data extraction unit acquires related information related to a target in a recognition target image which is a post-image obtained through photographing before and after treatment on a container that stores the target, and extracts recognition target data which is a combination of the recognition target image and the related information The recognition unit accepts the recognition target data as an input to a model learned in advance and outputs a recognition result obtained by recognizing an area where at least the container, the target, and a portion other than the target are divided by an output of the model. The ratio estimation unit estimates a ratio of the target in the recognition target image based on the recognition result and an area ratio in a pre-stored pre-image obtained through the photographing before and after the treatment. The model recognizes the area by converting the recognition target image into a feature amount map and calculating the feature amount map in a weighting manner by latent information obtained from the related information.

### TECHNICAL FIELD

A technology of the present disclosure relates to a recognition device, a recognition method, a recognition program, a model learning device, a model learning method, and a model learning program.

### BACKGROUND ART

In the related art, semantic segmentation represented by U-Net or the like has been used as a scheme of recognizing what is photographed in an image (see NPL 1). What is photographed is expressed with a label for a rectangle in object detection, but is expressed with a label for each pixel in semantic segmentation. Therefore, an area of a subject can be finely ascertained.

### CITATION LIST

### Non Patent Literature

[NPL 1] 1: O. Ronneberger, P. Fischer, and T. Brox, “U-Net: Convolutional Networks for Biomedical Image Segmentation,” in MICCAI 2015.

### SUMMARY OF INVENTION

### Technical Problem

However, when difficulty of recognition is high, recognition accuracy may be low when only a semantic segmentation technology of the related art is applied using only image information as it is in some cases.

The disclosed technology has been made in view of the foregoing circumstances and an objective of the disclosed technology is to provide a recognition device, a recognition method, a recognition program, a model learning device, a model learning method, and a model learning program capable of recognizing an area of an image which is difficult to recognize.

### Solution to Problem

According to a first aspect of the present disclosure, a recognition device includes: a data extraction unit configured to acquire related information related to a target in a recognition target image which is a post-image obtained through photographing before and after treatment on a container that stores the target, and to extract recognition target data which is a combination of the recognition target image and the related information; a recognition unit configured to accept the recognition target data as an input to a model learned in advance and output a recognition result obtained by recognizing an area where at least the container, the target, and a portion other than the target are divided by an output of the model; and a ratio estimation unit configured to estimate a ratio of the target in the recognition target image based on the recognition result and an area ratio in a pre-stored pre-image obtained through the photographing before and after the treatment. The model recognizes the area by converting the recognition target image into a feature amount map and calculating the feature amount map in a weighting manner by latent information obtained from the related information.

According to a second aspect of the present disclosure, a model learning device includes: a recognition unit configured to accept a learning post-image obtained through photographing before and after treatment on a container that stores a target, a learning mask image corresponding to the post-image, and learning data including related information related to the target as an input, convert the image into a feature amount map by a model, and calculate the feature amount map in a weighting manner by latent information obtained from the related information to output a mask image in which an area where at least the container, the target, and a portion other than the target are divided is recognized as a recognition result; and a model update unit configured to digitize a difference between the mask image of the recognition result and a mask image included in the learning data as a loss and update a parameter of the model to reduce the loss.

### Advantageous Effects of Invention

According to the disclosed technique, it is possible to recognize an area of an image which is difficult to recognize.

### BRIEF DESCRIPTION OF DRAWINGS

FIG. 1 is a block diagram illustrating hardware configurations of a model learning device and a recognition device.

FIG. 2 is a block diagram illustrating a configuration of the model learning device according to an embodiment.

FIG. 3 is a diagram illustrating an example of a data structure of a learning information storage unit.

FIG. 4 is a diagram illustrating an example of a data structure of a related-information storage unit.

FIG. 5 is a block diagram illustrating a configuration of a recognition device according to the embodiment.

FIG. 6 is a diagram illustrating an example of a data structure of mask information.

FIG. 7 is a diagram illustrating an example of the data structure of output data of an output unit.

FIG. 8 is a diagram illustrating an example of a network configuration of semantic segmentation in a model.

FIG. 9 is a diagram illustrating an example in which weighted feature amount map calculation processing is performed on a channel component of a feature amount map.

FIG. 10 is a diagram illustrating an example in which weighted feature amount map calculation processing is performed on a spatial component of a feature amount map.

FIG. 11 is a flowchart illustrating a flow of model learning processing performed by the model learning device.

FIG. 12 is a flowchart illustrating a flow of recognition processing performed by a recognition device.

### DESCRIPTION OF EMBODIMENTS

Hereinafter, an example of an embodiment of a technology according to the disclosure will be described with reference to the drawings. In each drawing, the same or equivalent components and portions are denoted by the same reference numerals. Dimensional ratios of the drawings are exaggerated for convenience of description and may differ from actual ratios.

First, an overview of the disclosed technology will be described.

The technology for semantic segmentation can also be applied to, for example, a use case in which recognizes leftovers are recognized from an image obtained by photographing tableware after a meal.

However, as described in the foregoing problem, in the use case in which the leftovers are recognized from the image obtained by photographing the tableware after the meal, recognition accuracy may be low when only the semantic segmentation technology of the related art is applied using only the image information as it is. This is because the difficulty of recognition is high because the food left on a dish is not all leftovers but also includes residues not corresponding to leftovers. For example, when a liquid remains in a bowl, if a menu item is soup, the liquid is leftovers. If a menu item is ramen, it is considered that the liquid is not completely eaten. Therefore, the liquid should be residues not corresponding to leftovers. Other examples of the residues not corresponding to leftovers include the tails of shrimp, parsley, and stains of dishes caused by sauce or dressing.

In the following description of the embodiment, a mode in which the leftovers of tableware are recognized will be described as an example, but the mode can be applied to general recognition of a target in a container.

A configuration according to an embodiment will be described below. In the embodiment, each of a model learning device and a recognition device will be described.

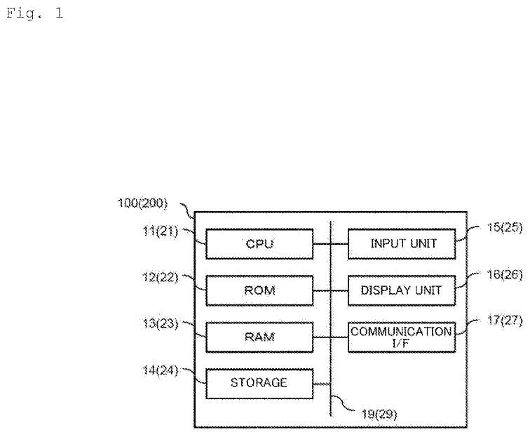

FIG. 1 is a block diagram illustrating a hardware configuration of a model learning device 100 and a recognition device 200. The model learning device 100 and the recognition device 200 can have the same hardware configuration.

As illustrated in FIG. 1, the model learning device 100 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit and executes various programs or controls each unit. That is, the CPU 11 reads a program from the ROM 12 or the storage 14 and executes the program using the RAM 13 as a working area. The CPU 11 performs control of each configuration and various types of calculation processing according to programs stored in the ROM 12 or the storage 14. In this embodiment, a model learning program is stored in the ROM 12 or the storage 14.

The ROM 12 stores various programs and various types data. The RAM 13 temporarily stores programs or data as a working area. The storage 14 is configured with a storage device such as a hard disk drive (HDD) or a solid state drive (SSD), and stores various programs including an operating system and various types of data.

The input unit 15 includes a pointing device such as a mouse or a keyboard, and is used for various inputs.

The display unit 16 is, for example, a liquid crystal display and displays various types of information. A touch panel system may be employed as the display unit 16, which may function as the input unit 15.

The communication interface 17 is an interface for communicating with another device such as a terminal. For example, a wired communication standard such as Ethernet (registered trademark) or FDDI, or a wireless communication standard such as 4G, 5G, or Wi-Fi (registered trademark) is used for the communication.

The recognition device 200 similarly includes a CPU 21, a ROM 22, a RAM 23, storage 24, an input unit 25, a display unit 26, and a communication I/F 27. The components are communicatively connected to each other via a bus 29. A recognition program is stored in the ROM 22 or the storage 24. Since description of each unit of the hardware configuration is the same as that of the model learning device 100, description thereof will be omitted.

Next, each functional configuration of the model learning device 100 will be described.

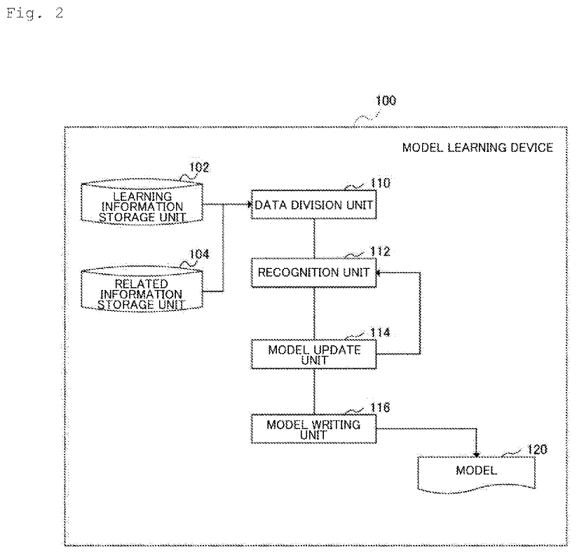

FIG. 2 is a block diagram illustrating a configuration of the model learning device 100 according to the embodiment. Each functional configuration is realized by causing the CPU 11 to read the model learning program stored in the ROM 12 or the storage 14, load the program to the RAM 13, and execute the program.

As illustrated in FIG. 2, the model learning device 100 includes a learning information storage unit 102, a related information storage unit 104, a data division unit 110, a recognition unit 112, a model update unit 114, a model writing unit 116, and a model 120.

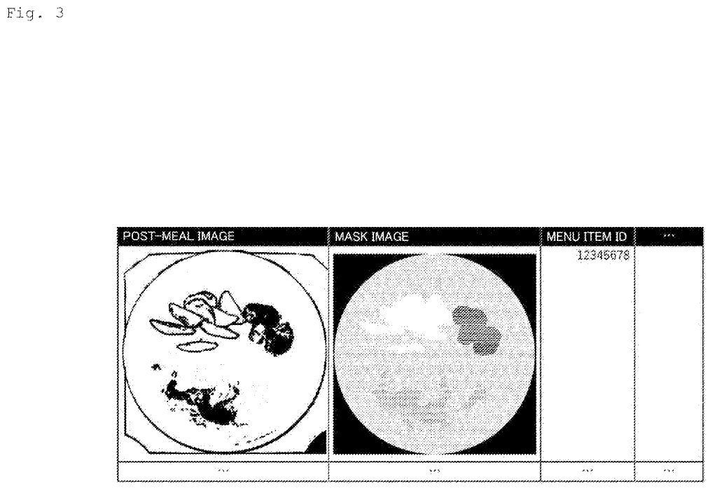

FIG. 3 illustrates an example of a data structure of the learning information storage unit 102. The learning information storage unit 102 is assumed to include at least a post-meal image, a mask image, and a menu item ID. The post-meal image is stored for learning past post-meal images. The mask image is obtained by manually masking (classifying) areas such as a background, a dish, leftovers, and residues not corresponding to leftovers in the post-meal images. The menu item ID is an ID of a menu item corresponding to the post-meal image and is used as a key when the table of the related information storage unit 104 is referred to. A dish is an example of a container according to the present disclosure. The leftovers (food) are an example of a target according to the present disclosure. The residues not corresponding to leftovers are an example of a portion other than the target according to the present disclosure. The post-meal image is an example of a pre-image photographed before and after treatment on a container containing a target according to the present disclosure. The treatment is applied to a meal in the present embodiment, the pre-treatment is pre-meal (at the time of serving) and the post-treatment is post-meal.

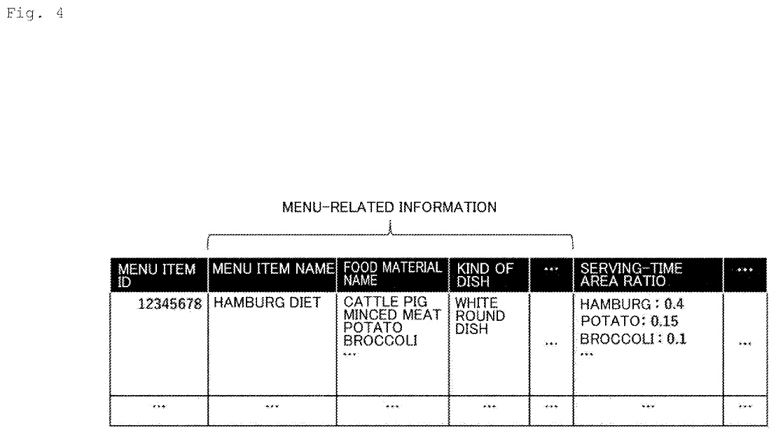

FIG. 4 is a diagram illustrating an example of a data structure of the related information storage unit 104. The related information storage unit 104 is assumed to include at least a menu item ID, menu-related information, and a serving-time area ratio. The menu-related information includes at least one piece of information related to a menu item such as a menu item name, a food material name, and a kind of dish. The serving-time area ratio is an area ratio of each food to the area of the dish at the time of serving. A result obtained as a numeral value in accordance with a method of inputting an image at the time of serving and the menu-related information to the recognition unit 112, calculating the serving-time area ratio from an output mask image, roughly calculating the serving-time area ratio visually from a serving-time image, or the like is stored. The menu-related information is an example of related information related to a target of the present disclosure. The related information related to the target includes the container and information other than the target. The serving-time area ratio is an example of the area ratio in a pre-image before and after the treatment according to the present disclosure is photographed.

The data division unit 110 divides learning data into learning data and test data by causing the learning information storage unit 102 and the related information storage unit 104 to serve as an input. The learning data and the test data are formed from menu-related information of the related information storage unit 104 which is referred to using the post-meal image, the mask image, and the menu item ID of the learning information storage unit 102 as keys. There is no structural difference between the learning data and the test data, and their uses in the model update unit 114 are different. The learning data and the test data are examples of learning data according to the present disclosure.

A parameter of a model is updated by repeating processing of the recognition unit 112 and the model update unit 114. A network configuration of the method will be described below.

The recognition unit 112 accepts the learning data and the test data as an input and recognizes areas in which a background, a dish, leftovers, residues not corresponding to the leftovers, and the like are divided through semantic segmentation of the model. The recognition result is outputted as a mask image. Although a configuration in which an input other than image information is assumed is not disclosed in the technology of the related art, a configuration in which menu-related information of the related information storage unit 104 is also input is provided in a scheme according to the present disclosure. Details of the image recognition unit 112 will be described below.

The model update unit 114 digitizes a difference between a mask image of a recognition result at the time of inputting of the learning data and a mask image included in the learning data as a loss, and updates a parameter of a model to reduce the loss. The model update unit 114 digitizes the degree of coincidence between the mask image of the recognition result at the time of inputting of the test data and the mask image included in the test data as a correct answer rate, and measures the generalization performance of the model. When a deterioration of the generalization performance is recognized from the previous learning, the learning is ended and the processing proceeds to processing of the model writing unit 116. When the deterioration of the generalization performance is not recognized, the learning is continued and the processing returns to the processing of the recognition unit 112.

The model writing unit 116 outputs the learned model 120 as an external file.

The features of the scheme according to the present disclosure are presence of menu-related information which is an input other than image information in the model learning device 100 and the recognition unit 112 handling the input other than the image information. As another configuration, a general configuration for learning a model in machine learning may be applied.

Next, each functional configuration of the recognition device 200 will be described.

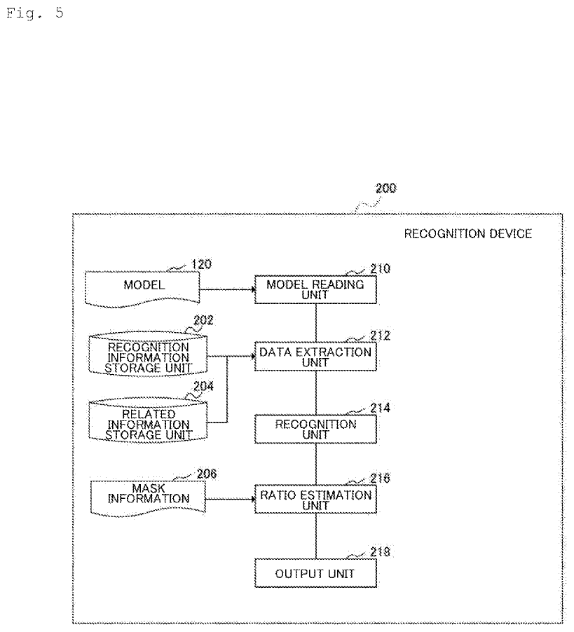

FIG. 5 is a block diagram illustrating a configuration of the recognition device 200 according to the embodiment. The functional configurations are realized by causing the CPU 21 to read a recognition program stored in the ROM 22 or the storage 24, load the recognition program to the RAM 23, and execute the recognition program.

As illustrated in FIG. 5, the recognition device 200 includes a model 120, a recognition information storage unit 202, a related information storage unit 204, mask information 206, a model reading unit 210, a data extraction unit 212, a recognition unit 214, a ratio estimation unit 216, and an output unit 218.

The model 120 is a learned model that has been learned by the learning device 100.

The recognition information storage unit 202 includes at least a post-meal image and a menu item ID as a data structure. The data structure of the recognition information storage unit 202 is a format in which a mask image is removed from the data structure of the learning information storage unit 102 illustrated in FIG. 3.

The related information storage unit 204 has a data structure similar to that of the related information storage unit 104 of the model learning device 100 and includes a menu item ID, menu-related information, and a servicing time area ratio.

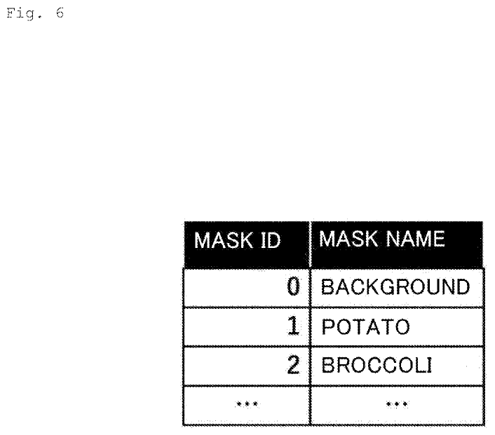

FIG. 6 illustrates an example of the data structure of the mask information 206. The mask ID is an ID of the color palette of the mask image, and the mask name is a name indicating what the mask corresponding to the ID is. For example, if number 0 of the color palette is black, RBG=(0, 0, 0), it means that a black area in the mask image of an index color is a background.

The model reading unit 210 reads a file of the model 120 and loads the file to a memory.

The data extraction unit 212 accepts the post-meal image of the recognition information storage unit 202 and menu-related information of the related information storage unit 204 as an input, and extracts recognition target data. The recognition target data includes a post-meal image and menu-related information corresponding to the post-meal image. Unlike the learning data and the test data, the mask image is not included in the recognition target data.

The recognition unit 214 accepts the recognition target data an input to the model 120, and outputs a recognition result obtained by recognizing areas in which a background, a dish, leftovers, and residues not corresponding to the leftovers are divided by an output of the model 120. The input model 120 accepting the input performs semantic segmentation. The recognition result is outputted as a mask image. The mask image is a mask image in which the input to the recognition unit 112 in model learning differs and the output mask image is the same.

The ratio estimation unit 216 estimates a leftover ratio based on the serving-time area ratio stored in the related information storage unit 204 and a mask image which is a recognition result output by the recognition unit 214. The mask image has an index color. Which is an index is solved by reading the mask information 206 in FIG. 6 and acquiring a mask name corresponding to a mask ID (index). A method of calculating the leftover ratio will be described below.

It is assumed that a numerical value of potato at the serving-time area ratio of the related information storage unit 204 is stored as 0.15, and a dish of 128 pixels, a potato of 24 pixels, broccoli of 18 pixels, and source stains of 30 pixels are photographed in a mask image. Since it is considered that the leftovers and the residues not corresponding to the leftovers are located on the dish, a ratio of an area of the potato to an area of the dish in the mask image can be calculated as follows:

$$24 \div ( 128 + 224 + 18 + 30 = 0.12 .$$

Accordingly, a ratio of leftovers is calculated as follows, and it can be calculated that 80% of the potato at the time of serving is leftovers:

$$100 * 0.12 \div 0.15 = 80.$$

When it is assumed that a leftover ratio in a certain food t is r₃, a serving-time area ratio is at, an object photographed in the mask image is m∈M, and the number of pixels of the object is pₘ, a general expression is obtained as the following Expression (1).

$$\begin{matrix}[ Math . 1 ] & \\ {r}_{t} = min ( 100 , \frac{100 {p}_{m = t}}{{a}_{t} {\sum }_{m ∈ M} {p}_{m}} ) & ( 1 )\end{matrix}$$

min is a function of returning a minimum value and is used to set the upper limit of the leftover ratio to 100%. Since the residues not corresponding to the leftovers are not leftovers, the leftover ratio is not calculated.

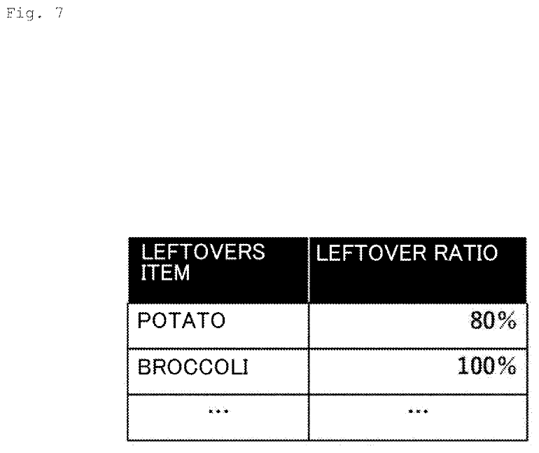

The output unit 218 outputs a calculation result of the leftover ratio of the ratio estimation unit 216 to an external system. An output data structure is output and changed in accordance with an input interface of the external system. FIG. 7 illustrates an example of a data structure of the output data of the output unit 218. A leftover item is the same as the mask name of the mask information 206. The leftover ratio is a value estimated by the ratio estimation unit 216.

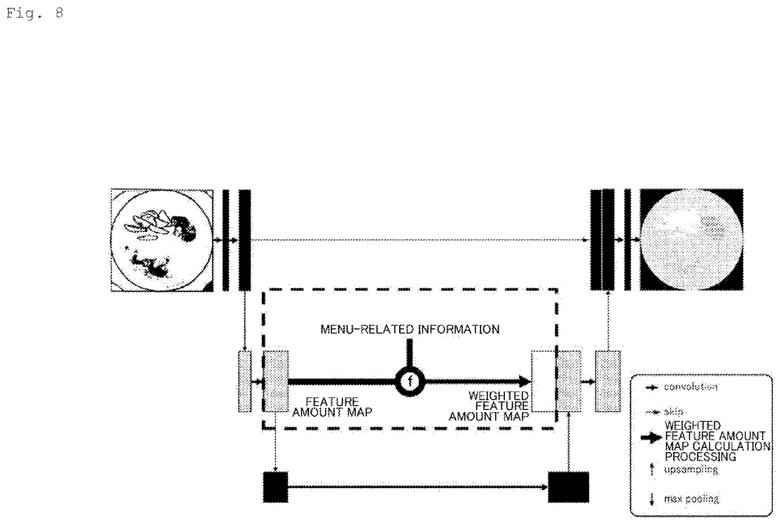

Next, a network of the model 120 will be described. FIG. 8 illustrates an example of a network configuration of semantic segmentation in the model 120. The input post-meal image is converted into feature amount maps of different shapes through processing such as convolution, maximum pooling, and upsampling to be finally output as a mask image. A portion surrounded by a dotted line is a feature in the network configuration. In this network configuration, menu-related information other than the post-meal image can be received as input, and a function of weighting a certain feature amount map by the menu-related information and outputting the certain feature amount map as a weighted feature amount map is provided. FIG. 8 illustrates an example in which the weighted feature amount map calculation processing is applied to a skipping portion in a middle stage. Since this processing can be applied to any feature amount map since the shape of the feature amount map is not changed before and after inputting and outputting. FIG. 8 illustrates an example in which the present processing is applied to only one location, it can be applied to a plurality of places. As the weighted feature amount map calculation processing, several processing methods can be considered. Two representative examples will be described below.

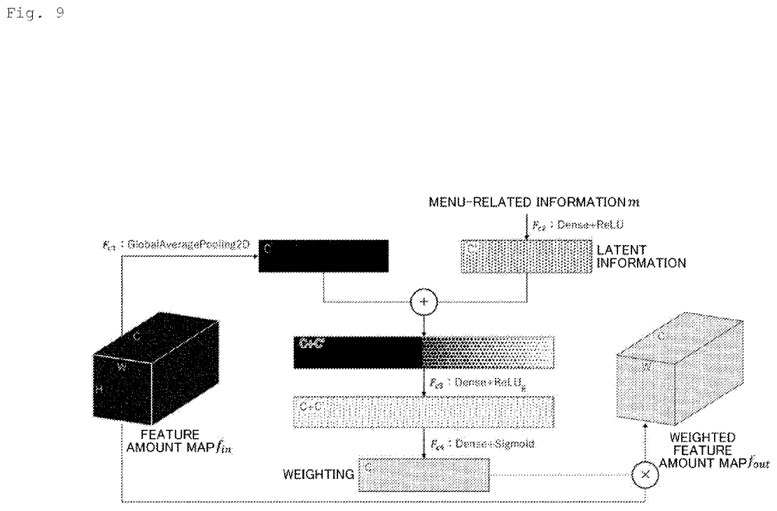

FIG. 9 illustrates an example in which weighted feature amount map calculation processing is performed on a channel component of the feature amount map. Both a feature value map fin of an input and a weighted feature amount map fₒᵤₜ of an output are shapes (H, W, C). When menu-related information m which is another one input is text data such as a menu item name, for example, the menu-related information m is converted into vectors for each word through word embedding after word division processing is performed through morphological analysis or the like. Then, preparation is made by obtaining an average value of vectors of all words included in a menu item name. In the case of category data such as a kind of dish, the menu-related information m is converted into vectors by one-hot encoding for preparation. The menu-related information m is converted into latent information C′ by a fully combined layer. When there are a plurality of information sources of the menu-related information, for example, when a menu item name and a kind of dish are simultaneously desired to be used, the plurality of information sources can be handled by setting the menu-related information m in which the vectors obtained from each of the plurality of information sources are connected. Therefore, it is possible to flexibly handle an increase or a decrease in additional information the information.

Calculation Expressions (2-1) and (2-2) for calculating a weight w_{c} of the channel component and the weighted feature amount map fₒᵤₜ are expressed below.

$$\begin{matrix}[ Math . 2 ] & \\ {w}_{c} = {F}_{c 4} ( {F}_{c 3} ( {F}_{concat} ( {F}_{c 1} ( {f}_{i n} ) , {F}_{c 2} ( m ) ) ) ) & ( 2 - 1 )\end{matrix}$$

$${f}_{out} = {w}_{c} ⊗ {f}_{i n} \qquad ( 2 - 2 )$$

F_{concat} (X, Y) is a function which means an operation of connecting tensors X and Y.

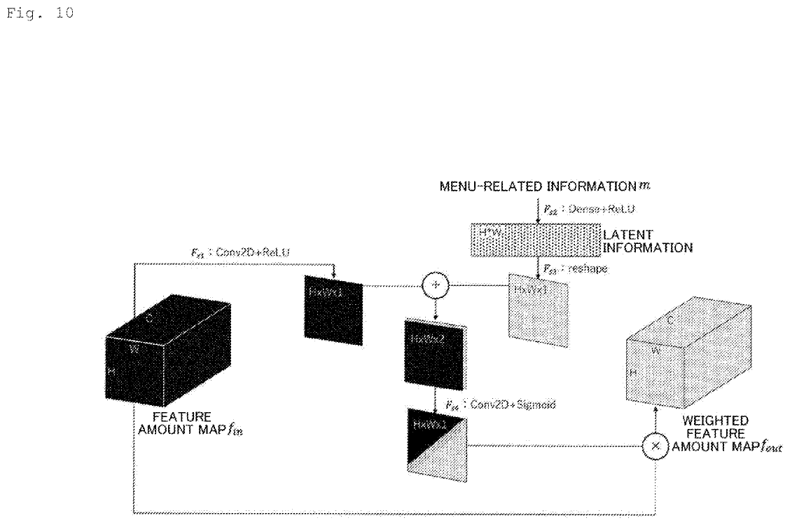

FIG. 10 illustrates an example in which the weighted feature amount map calculation processing is performed on a spatial component of the feature amount map. Since the weight is applied to the spatial component, the feature amount map and function are different from those when the weight is applied to the channel component, but an input and an output are the same.

Expressions (3-1) and (3-2) for calculating a weight wₛ of the spatial component and the weighted feature amount map fₒᵤₜ are illustrated.

$$\begin{matrix}[ Math . 3 ] & \\ {w}_{s} = {F}_{s 4} ( {F}_{concat} ( {F}_{s 1} ( {f}_{i n} ) , {F}_{s 3} ( {F}_{s 2} ( m ) ) ) ) & ( 3 - 1 )\end{matrix}$$

$${f}_{out} = {w}_{s} ⊗ {f}_{i n} \qquad ( 3 - 2 )$$

Next, operational effects of the model learning device 100 and the recognition device 200 will be described.

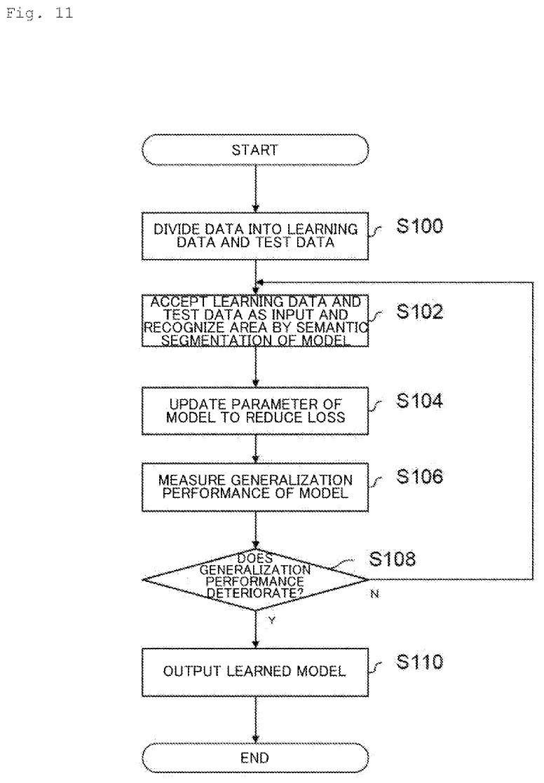

FIG. 11 is a flowchart illustrating a flow of the model learning processing performed by the learning device 100. The model learning processing is performed by causing the CPU 11 to read a model learning program from the ROM 12 or the storage 14, loading the model learning program to the RAM 13, and executing the model learning program.

In step S100, the CPU 11 serves as the data division unit 110 that divides data into learning data and test data by causing the learning information storage unit 102 and the related information storage unit 104 to serve as an input.

In step S102, the CPU 11 serves as the recognition unit 112 that accepts learning data and test data as an input and recognizes an area where the background, the dish, the leftovers, and the residues not corresponding to the leftovers are divided through semantic segmentation of the model.

In step S104, the CPU 11 serves as a model update unit 114 that digitizes a difference between a mask image of a recognition result at the time of inputting of the learning data and a mask image included in the learning data as a loss, and the parameter of the model is updated to reduce the loss.

In step S106, the CPU 11 serves as the model update unit 114 that digitizes the degree of coincidence between the mask image of the recognition result at the time of inputting of the test data and the mask image included in the test data as a correct answer rate and measures the generalization performance of the model.

Then, in step S108, the CPU 11 serves as the model update unit 114 that determines whether generalization performance deteriorates. When the generalization performance deteriorates from the previous learning time, the processing proceeds to step S110. When the generalization performance does not deteriorate, the processing returns to step S102 to repeat the processing.

In step S110, the CPU 11 serves as the model writing unit 116 that outputs the learned model 120 as an external file.

As described above, the learning device 100 according to this embodiment can learn the parameter of the model capable of recognizing an area of an image which is difficult to recognize.

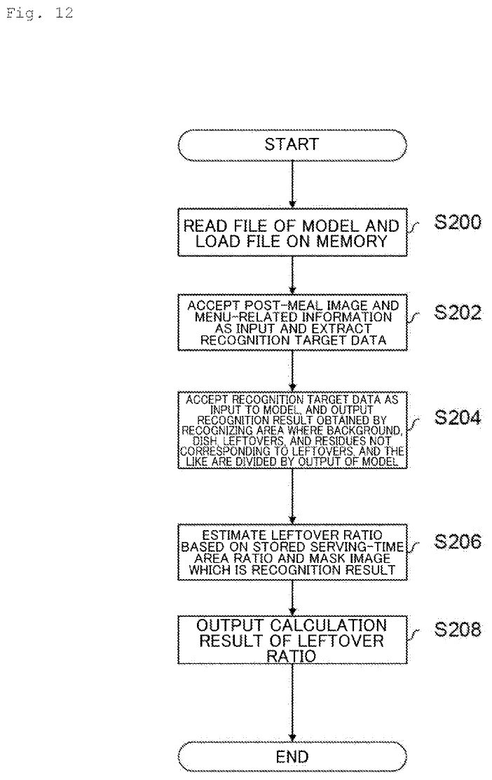

FIG. 12 is a flowchart illustrating a flow of recognition processing performed by the recognition device 200. The CPU 21 performs the recognition processing by reading the recognition program from the ROM 22 or the storage 24, loading the recognition program to the RAM 23, and executing the recognition program.

In step S200, the CPU 21 serves as the model reading unit 210 that reads a file of the model 120 and loads the file to a memory.

In step S202, the CPU 21 serves as the data extraction unit 212 that accepts the post-meal image of the recognition information storage unit 202 and menu-related information of the related information storage unit 204 as an input and extracts recognition target data.

In step S204, the CPU 21 serves as the recognition unit 214 that accepts the recognition target data as an input to the model 120 and outputs a recognition result obtained by recognizing the area in which the background, the dish, the leftovers, and the residues not corresponding to the leftovers are divided, by the output of model 120. The model 120 accepting the input performs the semantic segmentation. The recognition result is outputted as a mask image.

In step S206, the CPU 21 serves as the ratio estimation unit 216 that estimates a leftover ratio based on the serving-time area ratio stored in the related information storage unit 204 and the mask image which is the output recognition result.

In step S208, the CPU 21 serves as the output unit 218 that outputs a calculation result of the leftover ratio of the ratio estimation unit 216 to an external system.

As described above, the recognition device 200 of the present embodiment can recognize an area of an image which is difficult to recognize.

By using a relation between the latent information obtained from the menu-related information and the image information as a weight, a relation between the menu-related information and the leftovers and a relation between the menu-related information and the residues not corresponding to the leftovers can be learned, and thus recognition accuracy is improved.

The weight of the channel component or the spatial component of the feature amount map is calculated. Therefore, when a certain type of menu-related information is inputted for a certain type of image information, a channel or space of interest of the feature amount map is clear from magnitude of a weight value and a recognition basis can be described.

Any of various processors other than the CPU may perform the model learning processing executed by the CPU reading and executing software (program) in the foregoing embodiment. In this case, examples of the processor include a programmable logic device (PLD) of which a circuit configuration can be changed after manufacturing a field-programmable gate array (FPGA) or the like and dedicated electric circuits such as a graphics processing unit (GPU), and an application specific integrated circuit (ASIC) which are processors having circuit configurations designed exclusively to perform specific processing. Further, the model learning processing or the recognition processing may be performed by one of the various processors or may be executed by a combination of two or more processors of the same or different types (for example, a plurality of FPGAs and a combination of a CPU and an FPGA). More specifically, a hardware structure of the various processors is an electrical circuit in which circuit elements such as semiconductor elements are combined.

In the foregoing embodiment, the mode in which the model learning program or the recognition program is stored (installed) in advance has been described, but the present invention is not limited thereto. The program may be provided in a form stored in a non-transitory storage medium such as a compact disk read only memory (CD-ROM), a digital versatile disk read only memory (DVD-ROM), and a Universal Serial Bus (USB) memory. The program may be downloaded from an external device via a network.

The following additional supplements are disclosed in relation to the foregoing embodiments.

### (Supplement 1)

A recognition device including a memory, and at least one processor connected to the memory;
wherein
the processor performs:
acquiring related information related to a target in a recognition target image which is a post-image obtained through photographing before and after treatment on a container that stores the target, and extracting recognition target data which is a combination of the recognition target image and the related information;
accepting the recognition target data as an input to a model learned in advance and outputting a recognition result obtained by recognizing an area where at least the container, the target, and a portion other than the target are divided by an output of the model; and
estimating a ratio of the target in the recognition target image based on the recognition result and an area ratio in a pre-stored pre-image obtained through the photographing before and after the treatment,
wherein the model recognizes the area by converting the recognition target image into a feature amount map and calculating the feature amount map in a weighting manner by latent information obtained from the related information.

### (Supplement 2)

A non-transitory storage medium storing a program which can be executed by a computer to perform recognition processing including:
acquiring related information related to a target in a recognition target image which is a post-image obtained through photographing before and after treatment on a container that stores the target, and extracting recognition target data which is a combination of the recognition target image and the related information;
accepting the recognition target data as an input to a model learned in advance and outputting a recognition result obtained by recognizing an area where at least the container, the target, and a portion other than the target are divided by an output of the model; and
estimating a ratio of the target in the recognition target image based on the recognition result and an area ratio in a pre-stored pre-image obtained through the photographing before and after the treatment,
wherein the model recognizes the area by converting the recognition target image into a feature amount map and calculating the feature amount map in a weighting manner by latent information obtained from the related information.

### REFERENCE SIGNS LIST

100 Model learning device
102 Learning information storage unit
104 Related information storage unit
110 Data division unit
112 Recognition unit
114 Model update unit
116 Model writing unit
120 Model
200 Recognition device
202 Recognition information storage unit
204 Related information storage unit
206 Mask information
210 Model reading unit
212 Data extraction unit
214 Recognition unit
216 Ratio estimation unit
218 Output unit

1. A recognition device comprising:
a memory; and
at least one processor coupled to the memory, the at least one processor being configured to:
acquire related information related to a target in a recognition target image which is a post-image obtained through photographing before and after treatment on a container that stores the target, and to extract recognition target data which is a combination of the recognition target image and the related information;
accept the recognition target data as an input to a model learned in advance and output a recognition result obtained by recognizing an area where at least the container, the target, and a portion other than the target are divided by an output of the model; and
estimate a ratio of the target in the recognition target image based on the recognition result and an area ratio in a pre-stored pre-image obtained through the photographing before and after the treatment,
wherein the model recognizes the area by converting the recognition target image into a feature amount map and calculating the feature amount map in a weighting manner by latent information obtained from the related information.

2. The recognition device according to claim 1, wherein, in the model, the related information is configured to be converted into the latent information by a fully combined layer, and an information source of the related information is set as one or more pieces of information.

3. The recognition device according to claim 1, wherein the model performs weighted feature amount map calculation processing on a channel component or a spatial component of the feature amount map.

4. A model learning device comprising:
a memory; and
at least one processor coupled to the memory, the at least one processor being configured to:
accept a learning post-image obtained through photographing before and after treatment on a container that stores a target, a learning mask image corresponding to the post-image, and learning data including related information related to the target as an input, convert the image into a feature amount map by a model, and calculate the feature amount map in a weighting manner by latent information obtained from the related information to output a mask image in which an area where at least the container, the target, and a portion other than the target are divided is recognized as a recognition result; and
a model update unit configured digitize a difference between the mask image of the recognition result and a mask image included in the learning data as a loss and update a parameter of the model to reduce the loss.

5. A recognition method causing a computer to perform processing including:
acquiring related information related to a target in a recognition target image which is a post-image obtained through photographing before and after treatment on a container that stores the target, and extracting recognition target data which is a combination of the recognition target image and the related information;
accepting the recognition target data as an input to a model learned in advance and outputting a recognition result obtained by recognizing an area where at least the container, the target, and a portion other than the target are divided by an output of the model; and
estimating a ratio of the target in the recognition target image based on the recognition result and an area ratio in a pre-stored pre-image obtained through the photographing before and after the treatment,
wherein the model recognizes the area by converting the recognition target image into a feature amount map and calculating the feature amount map in a weighting manner by latent information obtained from the related information.

6. A model learning method causing a computer to perform processing including:
accepting a learning post-image obtained through photographing before and after treatment on a container that stores a target, a learning mask image corresponding to the post-image, and learning data including related information related to the target as an input, converting the image into a feature amount map by a model, and calculating the feature amount map in a weighting manner by latent information obtained from the related information to output a mask image in which an area where at least the container, the target, and a portion other than the target are divided is recognized as a recognition result; and
digitizing a difference between the mask image of the recognition result and a mask image included in the learning data as a loss and updating a parameter of the model to reduce the loss.

7. A non-transitory, computer-readable storage medium storing a recognition program causing a computer to perform processing including:
acquiring related information related to a target in a recognition target image which is a post-image obtained through photographing before and after treatment on a container that stores the target, and extracting recognition target data which is a combination of the recognition target image and the related information;
accepting the recognition target data as an input to a model learned in advance and outputting a recognition result obtained by recognizing an area where at least the container, the target, and a portion other than the target are divided by an output of the model; and
estimating a ratio of the target in the recognition target image based on the recognition result and an area ratio in a pre-stored pre-image obtained through the photographing before and after the treatment,
wherein the model recognizes the area by converting the recognition target image into a feature amount map and calculating the feature amount map in a weighting manner by latent information obtained from the related information.

8. A non-transitory, computer-readable storage medium storing a model learning program causing a computer to perform processing including:
accepting a learning post-image obtained through photographing before and after treatment on a container that stores a target, a learning mask image corresponding to the post-image, and learning data including related information related to the target as an input, converting the image into a feature amount map by a model, and calculating the feature amount map in a weighting manner by latent information obtained from the related information to output a mask image in which an area where at least the container, the target, and a portion other than the target are divided is recognized as a recognition result; and
digitizing a difference between the mask image of the recognition result and a mask image included in the learning data as a loss and updating a parameter of the model to reduce the loss.
